(19) United States
(12) Patent Application Publication
(10) Pub. No.: US 2024/0235113 A9
(43) Pub. Date: Jul. 11, 2024

(54) Electrical Connector With Dual Lock

(71) Applicant: EMICOL Eletro Eletrônica S.A., ltu (BR)

(72) Inventor: Fábio Fortunato Christiano, Itapira (BR)

(21) Appl. No.: 18/277,515

(22) PCT Filed: Feb. 17, 2022
(86) PCT No.: PCT/BR2022/050050

§ 371 Date: Aug. 16, 2023

(30) Foreign Application Priority Data
Feb. 17, 2021 (BR) BR102021002859-9
Feb. 17, 2022 (BR) BR1020220029873

(51) Int. Cl. H01R 13/627

(52) U.S. Cl. CPC H01R 13/6275

(57) ABSTRACT

An electrical connector provided with a secondary lock is described, which is pre-assembled on a female connector by movement in a first direction and locking of the male connector by a second movement in a direction orthogonal to the first direction. The lock has a pair of arms provided with teeth, which, upon pre-mounting, remain inserted and coupled inside respective intermediate windows. The locking of the female connector only occurs with the insertion of the male connector inside the female connector. The insertion releases the teeth of the lock, which thus, and only then, can be moved to its final locking position, locking the male connector.

### CROSS REFERENCE TO RELATED APPLICATIONS

This application is the United States national phase of International Patent Application No. PCT/BR2022/050050 filed Feb. 17, 2022, and claims priority to Brazilian Patent Application Nos. BR 10 2021 002859-9 filed Feb. 17, 2021 and BR 10 2022 002987 3 filed Feb. 17, 2022, the disclosures of which are hereby incorporated by reference in their entireties.

### BACKGROUND OF THE INVENTION

### Field of the Invention

The present invention refers to an electrical connector, male and female type, equipped with a primary and secondary double locking mechanism. More particularly, the present invention relates to a connector having an improved secondary lock.

### Description of Related Art

Within the field of electrical connectors, a multitude of types of connectors are known, intended to satisfy the specificities for which they are designed. Among the most common technical requests, the need for additional mechanisms to prevent the connectors from mutual disengagement stands out. For example, this type of technical request comes from equipment that, when in use, are subjected to vibrations, accelerations and similar movements.

In the most common connectors, the male connector penetrates the female connector and remains in it inserted only by contact friction, as in the case of residential power outlets. For more specific applications, the male connector has some type of projection or coupling, which mechanically couples a recess or window provided in the female connector, in order to guarantee its permanence inside the female connector, even under the most severe mechanical stresses. In this case, the disengagement may require a direct action on the primary lock, in order to release the lock before removing the male connector.

For the most extreme cases, as mentioned above, a solution has been adopted which uses a double lock, that is, providing in addition to the primary lock also a secondary lock, intended to increase the reciprocal mechanical lock after coupling the male connector on the female connector. By definition, a secondary lock comprises some type of device, or element, intended to quantitatively increase the mechanical linkage of the male connector to the female connector.

Document U.S. Pat. No. 8,747,146 teaches an electrical connector comprising a housing having at least one terminal receiving passageway, an opening positioned proximate at least one terminal receiving passageway, a primary latch for latching the electric connector to a mating connector, and a slot extending longitudinally along side the primary latch. The connector has a connector position assurance (CPA) member positionable in the opening and having a locking latch which is laterally offset from the primary latch of the housing. The CPA has first and second longitudinal positions. The first position where the CPA is in a partially inserted position and a second position where the housing is in a fully mated position within a mating connector housing and the CPA is in a fully inserted position.

Document U.S. Ser. No. 10/868,385 teaches a connector housing whose device, called connector position assurance (CPA) device, installed so as to be able to slide inside the housing, is activated by the front end of the complementary connector housing that is not the lug, commonly called locking nose for locking the housings to one another.

Document EP 3016213 relates to an electrical connector mounting comprising a plug connector. The plug connector comprises a connector housing having a flexible leg. The plug connector further comprises a secondary locking device having a jamming portion a flexible arm, which is in blocking contact with the flexible leg when the plug connector is not mated with a corresponding counter connector. The plug connector thereby allows for direct mating with a corresponding counter connector, whereby the secondary locking device provides connector position assurance functionality.

Despite documents U.S. Pat. No. 8,747,146, U.S. Ser. No. 10/868,385 and EP 3016213 making reference to male and female connectors featuring a secondary lock, none of them describe a mechanism that prevents the locking of the male connector by the secondary lock of the female connector exclusively when the male connector is fully inserted inside the female connector.

Despite the notable advantage of using a secondary lock to secure the connection between the connectors, they are not free from drawbacks. The main disadvantage verified is the fact that said lock is an extra component of the connector, and that it must be positioned only after coupling the male connector inside the female connector. For this purpose, said secondary lock usually comes pre-fitted in the female connector, in order to avoid that the female connector is supplied by the manufacturer as two different pieces—making the mounting operation potentially more complex. However, supplying the female connector with the secondary lock pre-fitted can lead to problems of relative displacement of the secondary lock, or even the release of the secondary lock, thus resulting in the need for, at least, a preliminary check of the condition of the female connector before mounting it on the device and/or connecting the male connector to it.

### OBJECTIVES OF THE INVENTION

Thus, an initial objective of the invention is to obtain an electrical connector equipped with a secondary lock and able to overcome the drawbacks of the previous state of the art.

Another objective of the invention is to obtain an electrical connector wherein the secondary lock can only be moved, from a rest position to a locking position, by the full penetration of the male connector inside the female connector.

Another objective of the invention is to obtain an electrical connector wherein the male connector is only able to penetrate the female connector when the secondary lock is in its retracted or resting position.

### SUMMARY OF THE INVENTION

These and other objectives are achieved by the electrical connector with a double lock having a main construction and its alternative embodiments according to the invention. For this purpose, the present invention comprises a female connector able to receive a secondary lock from a first direction, and to perform the definitive locking of the male connector from movement of the secondary lock in a second direction, orthogonal to the first direction of movement. Furthermore, the secondary lock is mounted on the female connector in an rearward position, and the secondary lock can only be moved to the forward locking position after inserting the male connector into the female connector.

In other words, the present invention comprises an electrical connector having a double lock, comprising: a male connector, to be mechanically and electrically coupled to a female connector; a primary lock, formed by a rod that can be flexed and comprising, at a free end of the rod, a straight tooth capable of mechanically locking said male connector inside the female connector in an electrically coupled position; a female connector having a parallelepiped conformation, with a frontal opening for insertion of the male connector by sliding, said female connector further having, laterally, a pair of rearward windows and a pair of forward windows, said windows arranged on the lateral faces of the female connector; and a secondary lock, defined by a shaped body provided with arms equipped with teeth at the free ends, said teeth being able to penetrate the forward windows or the rearward windows of the female connector according to the relative position of the secondary lock on the connector female, thus defining respectively an advanced locking position and a retracted position in which the rod can flex freely. A sliding part, which protrudes from the lower surface of the body of the secondary lock, comprises an end tooth, able to slide over the rod between a retracted position and an advanced position of locking, wherein when said end tooth is in said advanced position, it prevents the bending of the rod and the movement of the straight tooth.

In particular, the arms are L-shaped and protrude from the rear portion of the secondary lock body, and arched teeth are provided at the respective free ends of each arm. Alternatively, the arms have a straight rod conformation and protrude from the middle portion of the secondary lock body, with arched teeth being provided at the respective free ends of each arm.

Alternatively, the secondary lock comprises a column-shaped sliding part having a sloping front edge, the end tooth protrudes from the most advanced portion of said sliding part, the primary lock is defined by a flexible rod having a through opening in its central region, and the free end of the rod defines a monolithic tip comprising a straight tooth that protrudes from the lower surface of said tip; when the rod is flexed by the action of the straight tooth abutting against the male connector, said tip intercepts the trajectory of the end tooth of the secondary lock sliding part. Furthermore, the monolithic tip has a sloping top surface.

Pre-assembly of the lock on the female connector occurs by a fitting movement in a first direction, and by locking the male connector inside the female connector by movement of the lock in a second direction, orthogonal to the first direction, from the rearward mounting position to the forward locking position, after releasing the arched teeth from inside the rearward openings by the male connector.

### BRIEF DESCRIPTION OF THE DRAWINGS

The terms Fig., Figs., Figure, and Figures are used interchangeably in the specification to refer to the corresponding figures in the drawings.

The object of the present invention will be better understood in the light of the detailed description that follows, relating to preferred embodiments of the invention with support of the attached figures, used for illustrative and non-limiting purposes, in which:

FIG. 1 is a perspective view of a RAST type connector having the secondary lock according to the invention in the final locked position;

FIG. 2 is a perspective view similar to the previous one, wherein the male connector is coupled to the female connector and the secondary lock is in a pre-engaged condition;

FIG. 3 is a perspective exploded view of the connector;

FIGS. 4A-4C illustrate, in perspective exploded views, the sequence of steps for coupling and locking the male connector on the female connector;

FIG. 5 is a cross-sectional view, according to a horizontal section, of the connector of the invention, wherein the secondary lock is in the rearward position;

FIG. 6 is a cross-sectional view, according to a vertical section, of the connector of the invention, wherein the secondary lock is in the rearward position;

FIG. 7 is a perspective cross-sectional view, according to a vertical section orthogonal to the longitudinal axis of a first alternative embodiment of the invention;

FIGS. 8A and 8B are cross-sectional views of the solution in FIG. 7, wherein, respectively, the secondary lock is in the backward position with the male connector inserted, and the secondary lock is in the forward position with the primary lock;

FIG. 9 is a side elevation view of the solution in FIG. 7, with the secondary lock having its movement prevented by the primary lock;

FIG. 10 is a perspective view of a second alternative embodiment of the invention; and

FIG. 11 is a cross-sectional view of the solution in FIG. 10, according to a vertical plane.

### DESCRIPTION OF THE INVENTION

In accordance with the figures identified above, (1) generally indicates a RAST type electrical connector, that is, a multifilament connector. Said electrical connector (1) is defined by a male connector (2) capable of being received and electrically coupled to a respective female connector (3).

Despite the embodiments are described referring to a RAST type connector, technicians will readily identify that the locking mechanism described herein can also be applied to several other types of electrical connectors equipped with a secondary lock.

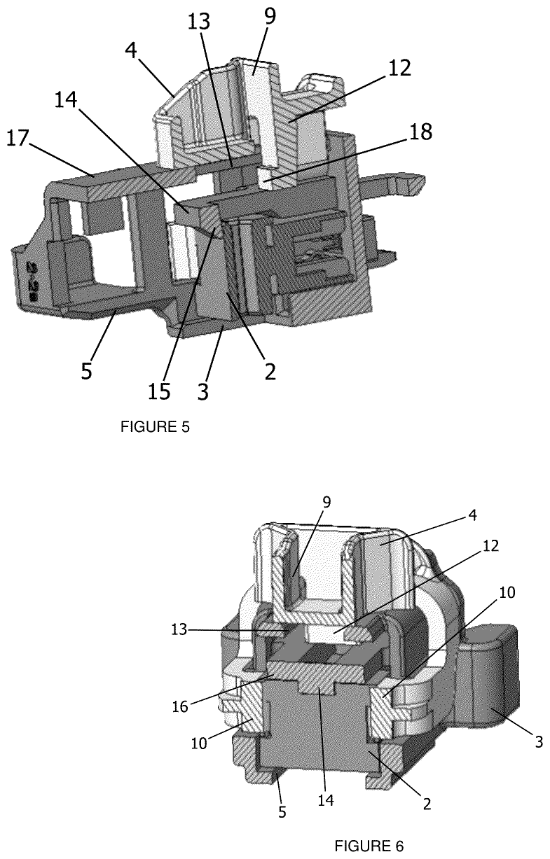

Furthermore, the male connector (2) is maintained in the coupled condition, in relation to the female connector (3), by means of a double lock system, which comprises a primary lock (14) of a known type (see FIG. 5) and a secondary lock (4). As illustrated, said primary lock (14) is a conventional mechanism in which a rod (15) of the female connector (3) has a tooth (16) arranged at a free end of said rod (15), wherein the rod (15) is displaced due the insertion of the male connector (2) inside the female connector (3), through mechanical interference of the male connector body (2) on the straight tooth (16) of the primary lock (14). At this point, it is imperative to point out that said secondary lock (4), object of the present invention, is not intended to define a second lock to prevent the removal of the male connector (2) from inside the female connector (3), but to act directly on the primary lock (14) itself, preventing said primary lock (14) from being unlocked, either by a direct and voluntary action by the user, or by an involuntary and accidental action, such as the vibration of the equipment in which said RAST connector is being used. In other words, the secondary lock (4) is, in fact, an overlock or lock of the lock, in relation to the primary lock (14) of the male connector (2).

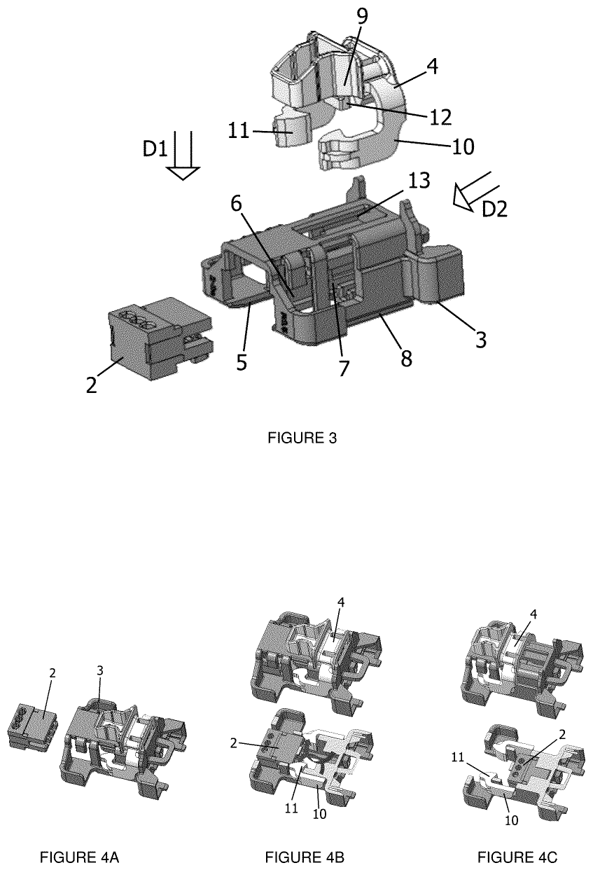

FIG. 3 is a perspective exploded view of the electrical connector (1) according to the invention, in which the secondary lock (4) is in its rearward position, that is, it is not mechanically interfering with the primary lock (14). As can be seen, said female connector (3) has a general parallelepiped shape, having a front opening (5) able to allow insertion of the male connector (2) by sliding it in the longitudinal direction (D2) of the female connector (3). Said female connector (3) further has, laterally, a pair of rearward windows (6) and a pair of forward windows (7), said windows (6, 7) extending along almost the entire height of the lateral faces (8) of the female connector (3). The female connector (3) further comprises a primary lock (14) formed by a longitudinal rod (15) having a central through opening (20), whose portion closest to the front opening (5) defines a straight tooth (16), as best illustrated in FIG. 6. Said primary lock (14) has a lower position in relation to the upper face (17) of the female connector (3) and above the male connector (2), when the latter is inserted in the connector female (3). In addition, a free space is provided between the primary lock (14) and the upper face (17) so that, when the male connector (2) is being inserted, the rod (15) of the primary lock (14) can be bend upwards (according to the orientation of FIG. 5), by mechanical action of the male connector (2) on the straight tooth (16). In addition, the upper face (17) of the female connector (3) has a slot (13) which extends longitudinally along an extension corresponding to that of the rod (15) of the primary lock (14).

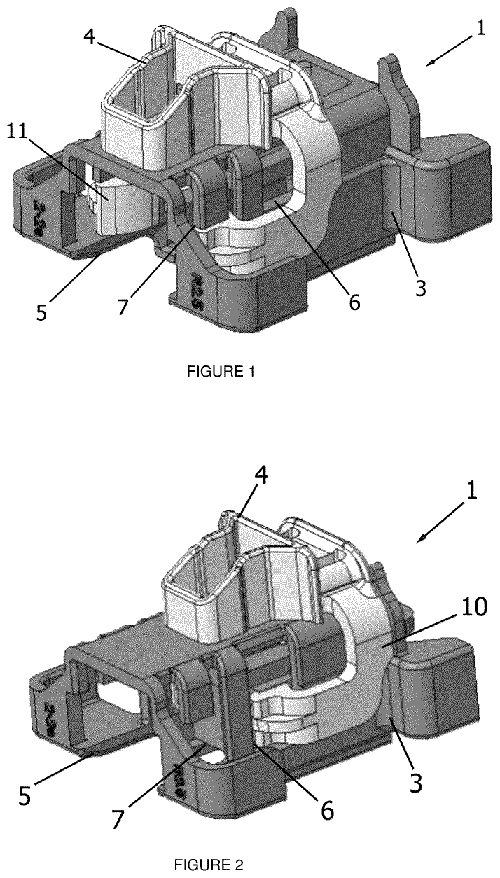

Said secondary lock (4) is defined by a body (9) able to be handled by a user, as well as able to slide over the upper face (17) of the female connector (3), with controlled movement by a sliding part (12) that moves inside the respective slot (13) of the upper face (17) of the primary lock (14). Said sliding part (12) also has an end tooth (18) which acts so that the secondary lock (4) is engaged in the female connector (3) when it is in its forward locking position (FIG. 1). Furthermore, said sliding part (12) also acts as a blocking element for the primary lock (14). More specifically, said sliding part (12) has the shape of a column that protrudes from the lower face of the body (9) of the secondary lock (4). The lower end of the sliding part (12) defines an end tooth (18) whose height corresponds to said free space between the primary lock (14) and the upper face (17) of the secondary lock (4). In the advanced position (FIG. 1) of the secondary lock (4), said end tooth (18) is positioned exactly between the straight tooth (16) of the rod (15) and the upper face (17) of the female connector (3), thus preventing any type of bending of the rod (15) even when there is a more intense mechanical stress.

A pair of arms (10) project symmetrically downward from the body (9), which, in the mounted condition of the secondary lock (4) in relation to the female connector (3), are arranged on the side faces (8) of the lock (4). Each of said arms (10) is L-shaped, ending in a respective arched tooth (11) facing inwards. More specifically, the arched teeth (11) are sized so that, with the secondary lock (4) in a rearward position (see FIG. 2), which corresponds to a pre-engaged condition of the secondary lock (4) relative to the female connector (3), said arched teeth (11) penetrate inside the respective rearward windows (6). When the secondary lock (4) is in the advanced position (see FIG. 1), said arched teeth (11) assume a position corresponding to the forward windows (7) of the secondary lock (4).

The use and mounting of a connector (1) according to the invention is quite simple and, above all, safe with relation to the transport, handling and maintenance of the male connector (2) coupled and electrically connected to the female connector (3).

Initially, the component parts (2, 3 and 4) of the connector (1) are manufactured according to appropriate techniques. Then, the secondary lock (4) is mounted on the female connector (3) by a fitting movement according to a first direction and orientation D1 (see FIG. 3). With this movement, the secondary lock (4) overlaps laterally and superiorly in relation to the body (8) of the female connector (3), the sliding part (12) penetrates the slot (13) and, most importantly, the arched teeth (11) penetrate the rearward windows (6) of the side faces (8) of the female connector (3). Once the arched teeth (11) are properly inserted in the rearward windows (6), this set can be widely handled and transported without risk of disengagement.

In the final step, that is, performed by the end user [e.g., the manufacturer of equipment that will use said connector (1)], this user attaches the filaments (not shown and in a way known in the art) to the male connector (2), and then promotes the coupling of the male connector (2) to the female connector (3), as illustrated in FIGS. 4A-4C. FIGS. 4A-4C illustrate, in detail, the engagement sequence of a male connector (2) on a female connector (3), both visible separately and in the engagement position in FIG. 4A. In order to facilitate the identification of the movements performed by each of the component parts of the female connector (3), the primary lock (14) and the secondary lock (4), the images in FIGS. 4B and 4C correspond to a view of the mounting from above disposed in a cross-sectional view along a horizontal plane.

Specifically, the male connector (2) is inserted into the female connector (3) from its front opening (5), using a rectilinear movement directed by guides or longitudinal fittings (not shown). With the movement of the male connector (2) inside the female connector (3), the male connector (2) intercepts the straight tooth (16) of the primary lock (14), bending the rod (15) upwards, and then intercepts the arched teeth (11), moving them outwards—specifically see FIG. 4B and in particular the cross-sectional view (bottom layout) in which a pair of arrows illustrates the interference of the male connector (2) on the arched teeth (11) of the secondary lock (4), and the respective displacements of these teeth (11) out of the rearward windows (6). Once the male connector (2) reaches its end of stroke position, the male connector body (2) still acts on the arched teeth (11) keeping them outside the rearward windows (6) of the female connector (3). In this way, the secondary lock (4) can be moved from its recessed position (mounted position) to its forward locking position, according to the direction D2 (FIG. 3). Said direction D2 is a direction orthogonal to the direction D1.

When the secondary lock (4) is thus displaced, the arched teeth (11) advance towards the forward windows (7), penetrating them and thus keeping the secondary lock (4) in its forward locking position, as illustrated in FIG. 4C. With the advance movement of the secondary lock (4) the sliding part (12) advances inside the groove (13) until its end of stroke position, in which the end tooth (18) is positioned between the upper face (17) and the straight tooth (16) of the rod (15), in order to completely block any type of bending of the rod (15) and, therefore, the removal of the male connector (2) voluntarily or involuntarily.

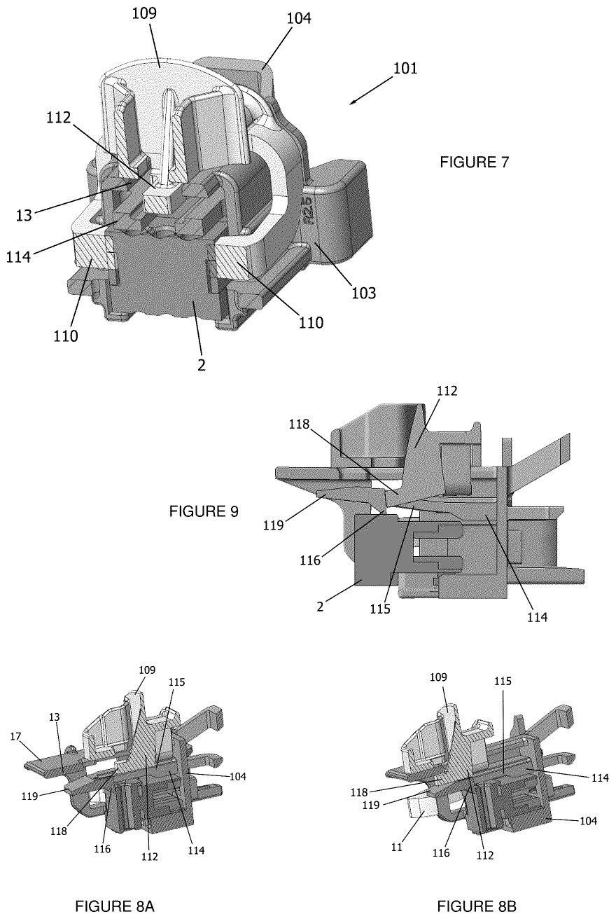

In an alternative embodiment of the present invention, as illustrated in FIGS. 7-9, the electrical connector (101) aims to mechanically prevent the advancement/locking of the secondary lock (104) if the male connector (2) is not fully inserted into the female connector (103).

In this alternative embodiment, the sliding part (112) has the form of a column having a sloping front edge that protrudes from the lower face of the body (109) of the secondary lock (104). The lower end of the sliding part (112) defines an end tooth (118) that protrudes from the most advanced portion of said sliding part (112), and whose height corresponds, similarly, to said free space between the primary lock (114) and the upper face (17) of the secondary lock (104). As in the previous embodiment, the upper face (17) has the slot (13) through which the sliding part (112) and the respective end tooth (118) move. However, as can be appreciated from a comparison between FIG. 7 and FIG. 5, the position of the end tooth (118) protruding from the sliding part (112) is more advanced compared to the position of the end tooth (18) of the sliding part (12).

Also in a similar way, the primary lock (114) is defined by a flexible rod (115) having a through opening (20) in its central region, having a straight tooth (116) protruding downwards from its front end, i.e. towards the male connector (2).

Particularly, in the first alternative embodiment, the monolithic tip (119) protrudes beyond the rod (115) from the straight tooth (116), and does not have any type of slot or central opening, such as the rod (115). Furthermore, the upper surface of the tip (119) has a slight downward slope, while the lower surface is parallel to the horizontal plane.

FIGS. 8A and 8B illustrate the female connector (103) with the male connector (2) fully inserted. In FIG. 8A, the secondary lock (104) is in its rearward position, that is, without offering any mechanical impediment to the flexion of the rod (115) of the primary lock (114). Thus, as the male connector (2) penetrates the female connector (103), the rod (115) flexes upwards without any obstacle as the sliding part (112) passes through the slot (113) of the upper face (17), as well as the through opening (20) of the rod (115) of the primary lock (114). Conversely, FIG. 9 illustrates a mounting situation in which the male connector (2) has not been fully inserted inside the female connector (103). In this case, the rod (115) remains flexed upwards due to the interaction between the straight tooth (116) and the male connector (2). Furthermore, said slope of the upper surface of the tip (119) allows the rod (115) to flex without contact with the lower surface of the upper face (17) of the female connector (3). However, the end tooth (118) is blocked by the tip (119), in an elevated position. In other words, with the rod (115) flexed by the action of the straight tooth (116) on the male connector (2), said tip (119) intercepts the trajectory of the end tooth (118) of the sliding part (112) of the secondary lock (104).

Thus, if the user has not noticed that the insertion of the male connector (2) inside the female connector (103) was not total and complete, with potential impairment of the electrical connection of the electrical connector (1), then the impossibility of advancing the secondary lock (104) clearly informs the user about this anomalous condition of incomplete coupling of the male connector (2).

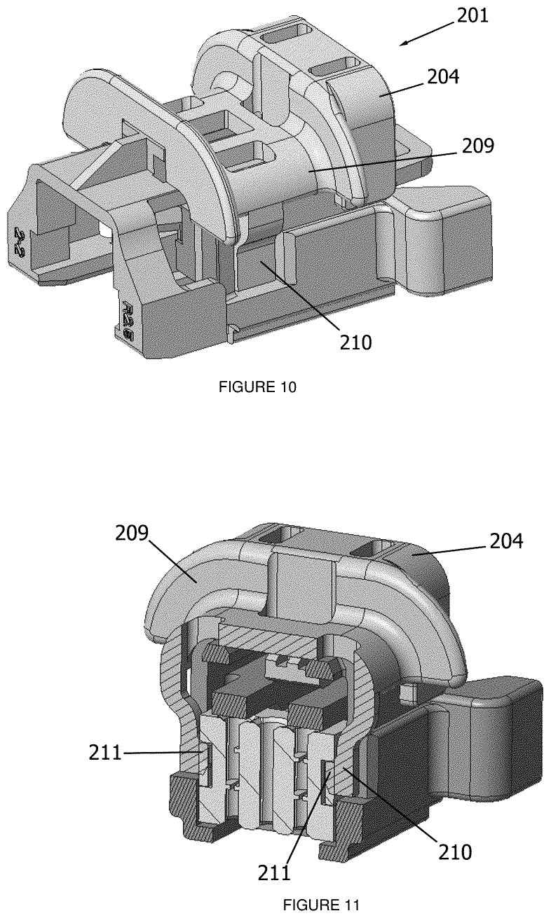

FIGS. 10 and 11 illustrate a second constructive alternative relative to the solution of the present invention. In this alternative embodiment, the arms (210) of the secondary lock (204) have a straight rod conformation, and protrude from the body (209) from an intermediate and more advanced position compared to the arms (10) of the secondary lock (4) of the first embodiment of the invention.

Similarly, each of the arms (210) has an arched tooth (211) facing the inside of the female connector (3), so as to penetrate either the rearward windows (6) or the intermediate windows (7) according to the position of the secondary lock (204) in relation to the female connector (3).

1. An electrical connector with double lock, comprising:
a male connector, to be mechanically and electrically coupled to a female connector;
a primary lock, formed by a rod capable of being bent and comprising, at a free end of the rod, a straight tooth able to lock mechanically said male connector inside the female connector in an electrically coupled position;
a parallelepiped-shaped female connector, having a front opening to slide and insert the male connector, said female connector further having, laterally, a pair of rearward windows and a pair of forward windows, said windows arranged on the side faces of the female connector; and
a secondary lock, defined by a shaped body and provided with arms having, at its free ends, teeth, said teeth being able to penetrate the forward windows or the rearward windows of the female connector according to the relative position of the secondary lock on the female connector, thus defining respectively a forward locking position and a rearward position in which the rod can flex freely;
wherein a sliding part, which projects from the lower surface of the body of the secondary lock, comprises an end tooth, able to slide on the rod between a rearward locking position and a forward locking position, and wherein, in said forward position, said end tooth prevents the bending of the rod and the movement of the straight tooth and
wherein the pre-mounting of the lock on the female connector occurs by a fitting movement in a first direction, and by locking the male connector inside the female connector by displacing the lock in a second direction orthogonal to the first direction, from the rearward mounting position to the forward locking position, after releasing the arched teeth from inside the rearward openings by the male connector.

2. The connector, according to claim 1, wherein the arms are L-shaped and protrude from the rear portion of the body of the secondary lock, wherein arched teeth are provided at respective free ends of each arm.

3. The connector, according to claim 1, wherein the arms have straight rod conformation and protrude from the intermediate portion of the body of the secondary lock, wherein arched teeth are provided at respective free ends of each arm.

4. The connector, according to claim 1, wherein the secondary lock comprises a column-shaped sliding part having a sloping front edge; the end tooth protrudes from the most advanced portion of said sliding particular; the primary lock is defined by a flexible rod having a through opening in its central region, and the free end of the rod defines a monolithic tip comprising a straight tooth that protrudes from the lower surface of said tip; when the rod is flexed by the action of the straight tooth abutting against the male connector, said tip intercepts the trajectory of the end tooth of the sliding part of the secondary lock.

5. The connector, according to claim 4, wherein the monolithic tip has an sloping upper surface.

6. (canceled)
